(19) United States
(12) Patent Application Publication
(10) Pub. No.: US 2006/0026292 A1
(43) Pub. Date: Feb. 2, 2006

(54) Data communication method and information processing apparatus for acknowledging signal reception by using low-layer protocol

(75) Inventors: Yoshimitsu Namioka, Tokai (JP); Takeshi Miyao, Hitachiota (JP)

Correspondence Address: MCDERMOTT WILL & EMERY LLP, 600 13TH STREET, N.W., WASHINGTON, DC, 20005-3096, US

(73) Assignee: HITACHI, LTD., Tokyo (JP)

(21) Appl. No.: 11/212,765

(22) Filed: Aug. 29, 2005

Related U.S. Application Data
(63) Continuation of application No. 10/671,874, filed on Sep. 29, 2003.

(30) Foreign Application Priority Data
Sep. 30, 2002 (JP) 2002-284712

(51) Int. Cl. G06F 15/16

(52) U.S. Cl. 709/230

(57) ABSTRACT

In a data communication method and information processing apparatus which is highly secure against attack to a computer, data is transmitted from a first computer to a second computer, a confirmation signal of data reception at the second computer is transmitted from the second computer to the first computer, data transmission from the second computer to the first computer is restricted, and data reception at the second computer is confirmed by using a protocol at a lower layer.

### BACKGROUND OF THE INVENTION

The present invention relates to a data communication method and information processing apparatus for computers communicating each other.

In network systems typically the Internet, in order to protect systems and manage the operation thereof, data communication apparatuses called routers or fire walls are installed on communication paths between computers. Communications from a first computer system to be protected to a second computer system are controlled to be permitted and conversely communications from the second computer system to the first computer system are controlled to be rejected. This control is realized logically by software. Such technologies are described, for example, in JP-A-2000-156711.

In controlling UDP (user datagram protocol) communications widely used in general, on the assumption that the operations by the first computer system are legal, a data communication apparatus judges the contents of a packet, and if the packet was transmitted from the first computer system to the second computer system, the data communication apparatus permits packet communications, whereas if the packet was transmitted from the second computer system to the first computer system, the data communication apparatus rejects packet communications.

In controlling TCP (transmission control protocol) communications widely used in general like USP communications, if upon start of communications, a connection request transmission side is the first computer system, the communications are permitted, and this established connection is used for not only the packet to be transmitted to the second computer system but also a reception response of data transmitted from the second computer system to the first computer system and a disconnection packet. Conversely, if the connection request transmission side is the second computer system, the data communication system rejects the request.

For the securest system, computer systems may not be interconnected by a network but data in the first computer system may be stored in an external storage medium to manually supply it to the second computer system.

### SUMMARY OF THE INVENTION

Even if logical one-way communications from the first computer system to the second computer system are realized by installing a data communication apparatus such as a rooter and a fire wall between the first and second computer systems, two-way communications are possible if logical definition or environment definition is incorrect because a physical communication path is capable of two-way communications. In this case, illegal intrusion via the network is possible.

If the second computer system illegally intruded transmits a packet illegally forged to make the first computer system a packet transmission destination, to the data communication apparatus, the packet can be transmitted to the first computer system. In this case, it becomes possible to attack the first computer system and greatly obstruct the operation thereof by executing an attack program illegally created on the second computer system and transmitting a large number of packets to the first computer system via the data communication apparatus.

If a communication path physically exists from the second computer system to the first computer system, through which data is otherwise essentially inhibited to be transmitted by logical one-way communication settings, there is a possibility of attacking the first computer system, and if data is transmitted, this operation itself becomes attack.

It is an object of the present invention to provide high security against attack to a virtual computer.

In order to achieve the above object, data is transmitted from a first computer to a second computer, a confirmation signal of data reception at the second computer is transmitted from the second computer to the first computer, data transmission from the second computer to the first computer is restricted, and data reception at the second computer is confirmed by using a protocol at a lower layer.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating an overall configuration.

FIG. 2 is a diagram showing the structure of network communication lines.

FIG. 3 is a diagram illustrating communications between computers.

FIG. 4 is a diagram illustrating communications corresponding to a plurality of transmission/reception applications.

FIG. 5 is a diagram illustrating communications by division transmission.

### DETAILED DESCRIPTION OF THE EMBODIMENTS

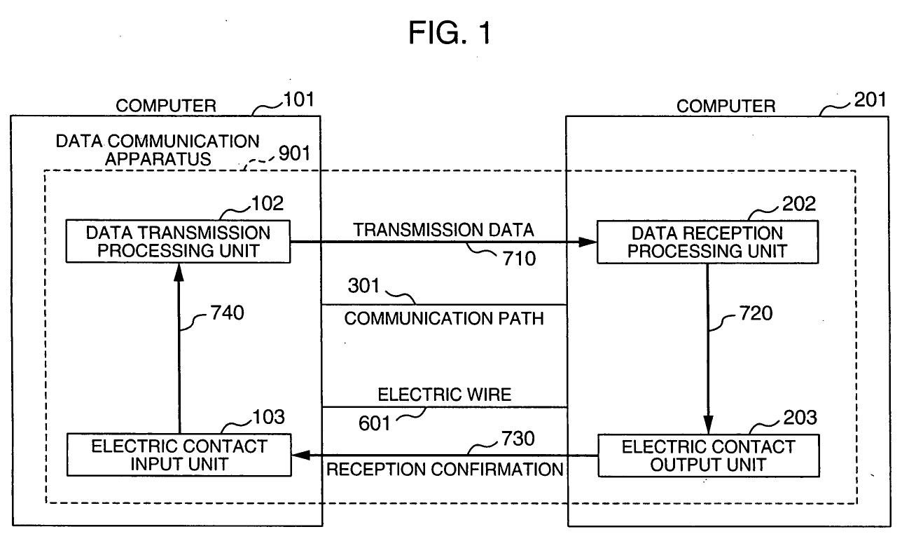

FIG. 1 is a block diagram showing a first embodiment of the invention. This block diagram illustrates transmission of data held in a computer 101 to another computer 201 connected by a communication path 301. The computer 101 as a data transmission source has a data transmission processing unit 102 and an electric contact input unit 103, and the computer 201 as a data reception destination has a data reception processing unit 202 and an electric contact output unit 203. The electric contact input and output units 103 and 203 are connected by an electric wire (or simply called a communication line) 601 between the computers 101 and 201, to constitute a data communication apparatus 901. The data transmission processing unit 102 transmits (710) data to the data reception processing unit 202. The data reception processing unit 202 received the data outputs (720) a contact output to the electric contact output unit (the electric contact input and output units are collectively called an electric contact) 710. The electric contact output unit 203 changes voltage or current of the electric wire 601 to notify (730) a reception completion to the electric contact input unit 103. For example, the electric contact input unit 103 detects that a signal was issued from the electric contact output unit 203 when the current or voltage at the electric contact input unit 103 becomes larger than or higher than a predetermined value. This communication is performed at a layer near the physical layer which is lower than that of the protocol stipulated in IEEE802.3 to be described hereinunder.

The electric contact input unit 103 detected a change in voltage or current at the contact notifies (740) a reception completion to the data transmission processing unit 102. The electric contact output and input units 203 and 103 are connected by the electric wire 601 as described above. This electric wire 601 is physically different from the communication path 301.

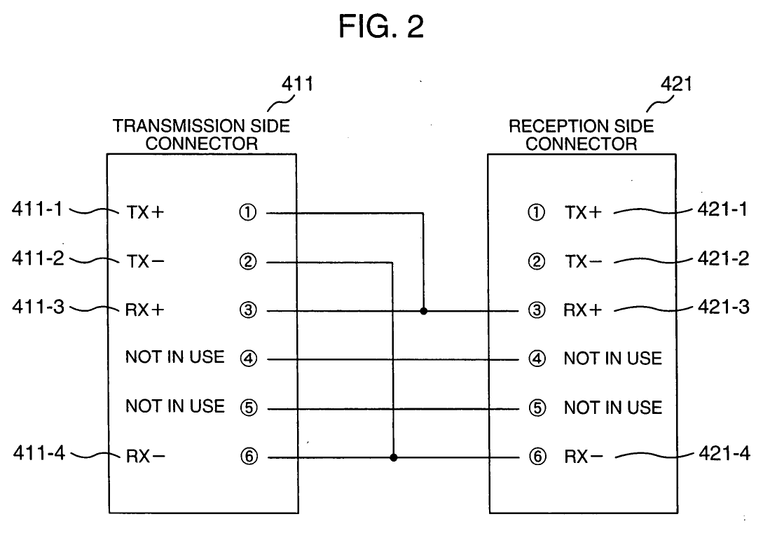

With reference to FIG. 2, description will be made on the structure of signal lines of the communication path 301 physically made only for one-way communications and shown in FIG. 1. A communication path conformal to a general 10BASE-T of IEEE802.3 has two pairs of electrically positive and negative electric lines to realize two-way communications. Namely, the communication protocol is provided with a physical layer, a data link layer and a network layer, and by using layers higher than these layers, data transfer is performed.

Connection of electrical wires of the communication path 301 at a transmission side connector 411 and a reception side connector 421 is changed. Generally, two-way communications requires two pairs of two-way communication wiring lines electrically connecting a terminal TX+ on the data transmission side to a terminal RX+ on the data reception side and connecting a terminal TX− on the data reception side to a terminal RX− on the data transmission side. An electric wire of a terminal TX+ 411-1 of a transmission side connector 411 is connected to an electric wire interconnecting a terminal RX+ 411-3 of the transmission side connector 411 and a terminal RX+ 421-3 of a reception side connector 421, and an electric wire of a terminal TX+ 411-2 of the reception side connector 411 is connected to an electric wire interconnecting a terminal RX− 411-4 of the transmission side connector 411 and a terminal RX− 421-4 of the reception side connector 421. There are therefore no communication lines between a terminal TX+ 421-1 of the reception side connector 421 and the terminal RX+ 411-3 of the transmission side connector 411 and between the terminal TX− 411-2 of the transmission side connector 411 and the terminal RX− 421-4 of the reception side connector 421. Data transmission is physically impossible from the reception side connector to the transmission side connector. Namely, by removing the electric wire of the terminals TX+ 421-1 and TX− 421-2 of the reception side connector of the computer 201, communications between the computers 201 and 101 are physically impossible although one-way communications are possible from the computer 101 to the computer 201. This physical removal of the connector electric wires for one-way communications is also defined in the protocol.

IEEE802.3 also defines the mechanism of detecting an abnormal state by using a link test pulse, a signal for monitoring the physical connection state. If the electric wires of TX+ and TX− or the electric wires of RX+ and RX− are removed from general communication apparatuses, the link test pulse cannot be received which is otherwise received from the partner apparatus, so that communications are impossible. In this embodiment, communications are possible because the link test pulse is forcibly made valid by connecting the terminal TX+ 411-1 to the terminal RX+ 411-3 on the transmission side and the terminal TX− 411-2 to the terminal RX− 411-4 on the transmission side.

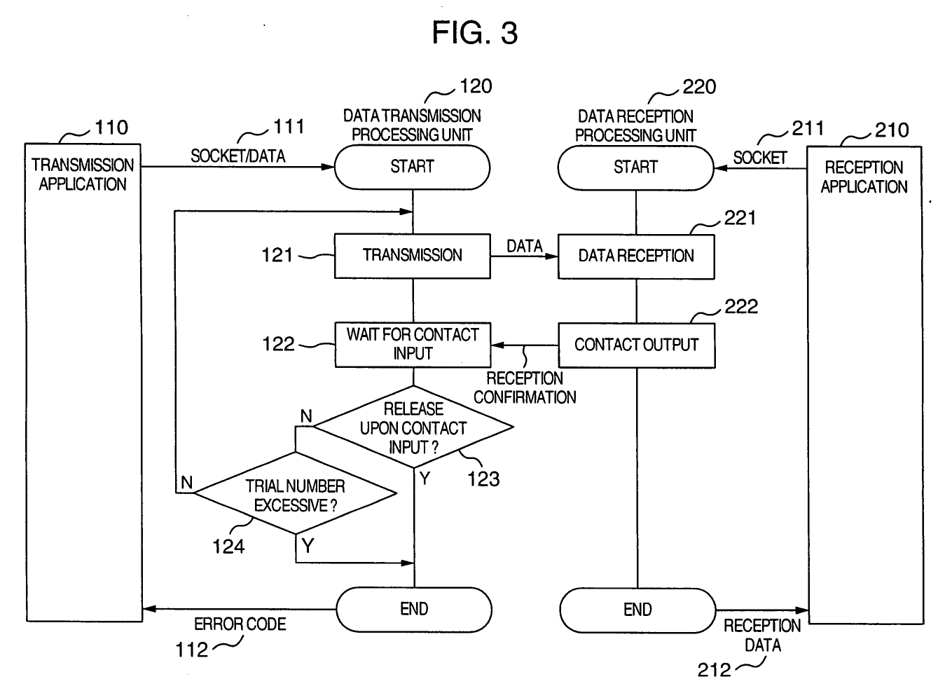

The communication scheme shown in FIG. 1 will be described with reference to FIG. 3. First, a data reception processing unit 220 receives (211) a socket capable of communication at a predetermined port number by a reception application 210, and enters (221) a data reception wait state by using the socket.

A data transmission processing unit 120 receives (111) a communication enabled socket and data from a transmission application 110, transmits (121) the data by utilizing known technologies, one-way communication scheme UDP or the like, and enters (122) a contact input wait state. The contact input wait state (122) is released when a timeout time lapses or a contact input is detected, the timeout time being set as a threshold value and being longer than a time taken to detect a contact input for a contact output. Upon reception of the data transmitted (121) from the data transmission processing unit 120, the data reception processing unit 220 issues (222) a contact output representative of a response of reception confirmation and supplies (212) the received data to the reception application 210. Information to be received by the transmission application 110 from the data transmission processing unit 120 may contain an amount of transmission data and the like, in addition to the socket and data. Information to be supplied to the reception application 210 from the data reception processing unit 220 may contain an amount of reception data, an error code and the like, in addition to the reception data.

Next, when the data transmission processing unit 120 detects a contact input representative of a response of reception confirmation, the contact input wait state (122) is released. The reason for release is checked (123). If the reason for release is a lapse of the timeout time, the number of present trials is checked (124) to perform re-transmission. If the number does not exceed a predetermined trial number, data is transmitted again (121), whereas if the number exceeds the predetermined number, without re-transmission an error code 112 representative of an error is returned to the transmission application 110 to thereafter terminate the communications. If the reason for release is a contact input, a size of the transmission data is returned to the transmission application 110 to thereafter terminate the communications and complete data transmission. Instead of the error code, the amount of transmission data may be returned.

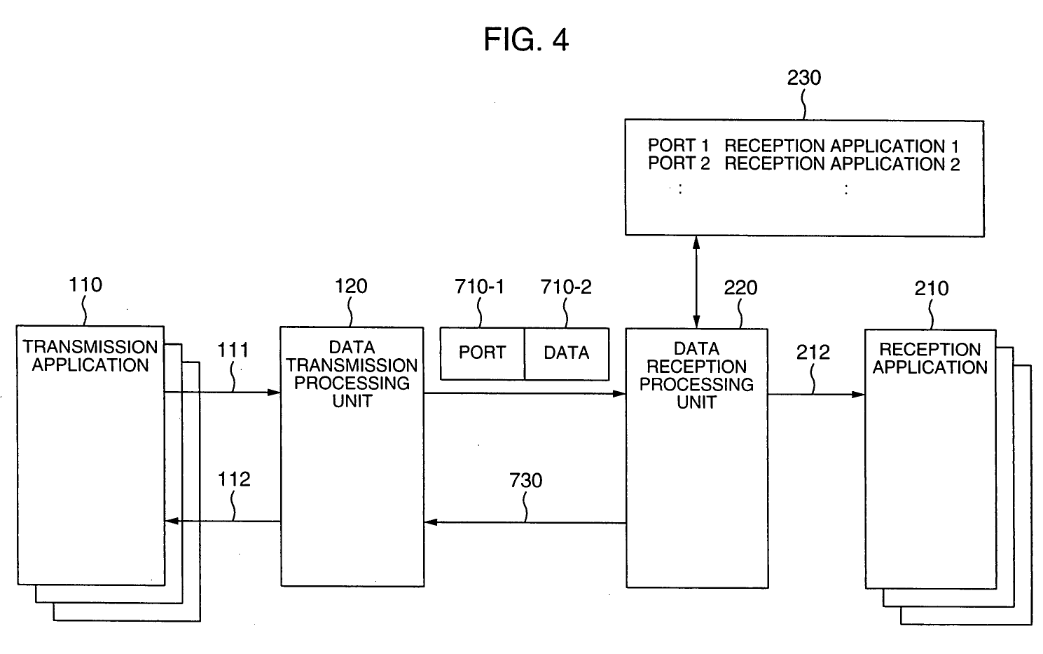

A second embodiment of the invention will be described with reference to FIG. 4. The second embodiment applies the communication scheme described with reference to FIG. 3 and allows a plurality of applications to perform communications. It is assumed that transmission applications 110 and a data reception processing unit 220 recognize before communications a port number list 230 storing a correspondence between each application and a port number, and that a plurality of reception applications 210 waits for reception at a predetermined port number. It is also assumed that the reception application 210 waits for reception at a port number indicated in the port number list 230.

Upon reception of a data transmission request from the transmission application 110, a data transmission processing unit 120 receives a socket and data as well as a port number in the state that transmission requests from other transmission applications are excluded, and transmits the data 710-2 with the port number 710-1 added to the start of the data to the data reception processing unit 220 of the computer 201. The data reception processing unit 220 separates the received data into the port number 710-1 and data 710-2, and transfers the data to the reception application 210 in a reception standby state at the derived port number to thereafter issue a contact output 220-2. Upon reception of the contact input, the data transmission processing unit 120 in the contact input wait state terminates transmission, and releases the exclusive state of other transmission requests to allow a transmission request to be received from another transmission application.

A plurality of data transmission processing units 120, data reception processing unit 220 and contacts to be used among these units may be prepared. In addition to the port number 710-1, data 710-2 and the like, management information such as a data size may be contained in transmission data.

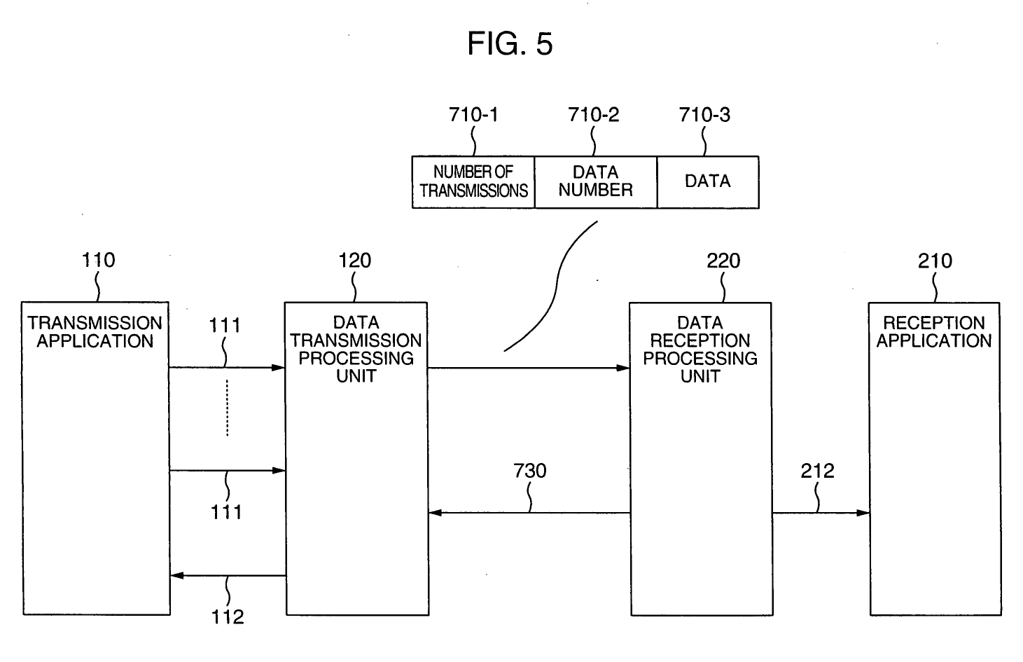

A third embodiment of the invention will be described with reference to FIG. 5, in which a transmission efficiency of the communication scheme can be improved by reducing the number of contact responses. First, upon reception of a socket, data and a data size as well as the number of transmission times and a data number from the transmission application 110, the data transmission processing unit 120 of the computer 101 transmits as the transmission data, the number 710-1 of transmission times, data number 710-2 and data 710-3. In this case, the data size may also be transmitted. The data transmission processing unit 120 receives the transmission requests repetitively same in number as the number of transmission times from the transmission application 110 while the data number is incremented or decremented, and transmits the data corresponding in amount to the number of transmission times to the data reception processing unit 220 of the computer 201. When the transmitted data becomes the last data, the data transmission processing unit 120 enters a contact input wait state. Next, the data reception processing unit 220 receives the data 710-3 corresponding in amount to the number 710-1 of reception times and confirms whether there is any duplicate or missing of the data number 710-2, and thereafter supplies the data to the reception application 210 to thereafter issue a contact output. The data transmission processing unit 120 releases the contact input wait state if the predetermined timeout time elapses or the contact input is detected, and notifies a transmission success/failure to the transmission application. In this case the data transmission processing unit 120 can urge the transmission application 110 to perform a re-transmission process by reporting a transmission failure to the transmission application 110.

In a fourth embodiment of the invention, data transmission may continue without the reception confirmation of a contact input by the data transmission processing unit 102 described with reference to FIG. 1, if it is not necessary to confirm whether the data was transmitted without any error.

In summary, although data held in the first computer system can be transmitted to the second computer system, data cannot be transmitted from the second computer system to the first computer system. Accordingly, data held in the first computer system can be made public to many and unspecified users at the second computer system.

Even if the second computer is illegally intruded, the second computer cannot physically communicate with the first computer system. It is therefore possible to prevent illegal intrusion and attack of obstructing services of the computer to be caused by transmission of a number of packets.

Although one-way communications are established, reception of data transmitted from the first computer system to the second computer system can be confirmed by using an electric contact. It is therefore possible to confirm whether the second computer system has received the transmitted data, and if not received, to transmit again the data.

As described so far, a communication method or information processing apparatus can be provided which is highly secure against attack to a virtual computer.

It should be further understood by those skilled in the art that although the foregoing description has been made on embodiments of the invention, the invention is not limited thereto and various changes and modifications may be made without departing from the spirit of the invention and the scope of the appended claims.

1-12. (canceled)

13. A data communication method comprising steps of:
transmitting data from a first computer to a second computer through a first communication line; and
transmitting information representative of reception of data through another communication line physically different from the first communication line to the first computer from the second computer.

14. An information processing apparatus having a first computer, comprising:
a data transmission processing unit which transmits data to a second computer through a first communication line; and
an input unit which inputs from the second computer a signal representative of reception of the data at the second computer through another communication line physically different from the first communication line.
